(19) United States
(12) Patent Application Publication
(10) Pub. No.: US 2025/0234018 A1
(43) Pub. Date: Jul. 17, 2025

(54) METHOD AND APPARATUS FOR ROI-BASED VIDEO ENCODING/DECODING FOR MACHINE VISION

(71) Applicants: Electronics and Telecommunications Research Institute, Daejeon (KR); Konkuk University Industrial Cooperation Corp, Seoul (KR)

(72) Inventors: Jin Young LEE, Daejeon (KR); Han Shin LIM, Daejeon (KR); Soon Heung JUNG, Daejeon (KR); Kyoung Ro YOON, Seoul (KR); Ye Gi LEE, Seoul (KR)

(73) Assignees: Electronics and Telecommunications Research Institute, Daejeon (KR); Konkuk University Industrial Cooperation Corp, Seoul (KR)

(21) Appl. No.: 19/021,668

(22) Filed: Jan. 15, 2025

(30) Foreign Application Priority Data
Jan. 16, 2024 (KR) 10-2024-0007052

(51) Int. Cl. H04N 19/30; H04N 19/167; H04N 19/17; H04N 19/20; H04N 19/70

(52) U.S. Cl. CPC H04N 19/30; H04N 19/167; H04N 19/17; H04N 19/20; H04N 19/70

(57) ABSTRACT

In the present disclosure, a method and a device for region of interest-based image encoding/decoding for machine vision may include extracting region of interest information in an image, performing an object tracking between frames based on the region of interest information, varying a resolution for each region of interest, and encoding an image with the region of interest information.

### CROSS-REFERENCE TO RELATED APPLICATIONS

This application claims the benefit of earlier filing date and right of priority to Korean Application NO. 10-2024-0007052, filed on Jan. 16, 2024, the contents of which are all hereby incorporated by reference herein in their entirety.

### TECHNICAL FIELD

The present disclosure relates to a method and device for encoding/decoding images based on region of interest for machine vision.

### BACKGROUND ART

Conventionally, video encoding/decoding technology has improved video compression efficiency and image quality by considering the human visual system. However, future video encoding/decoding technology is expected to be widely used not only for human vision but also in machine vision fields such as surveillance, intelligent transportation, smart cities, and intelligent industry.

Accordingly, there is a need to develop video encoding/decoding technology by which high-efficiency compression and recognition accuracy can be obtained by simultaneously considering human vision and machine vision.

### DISCLOSURE

### Technical Problem

The present disclosure aims to reduce the amount of data to be encoded/decoded through preprocessing of an input image.

The present disclosure aims to provide a method and device for encoding/decoding a transformed image based on a region of interest to increase compression efficiency while maintaining machine mission performance.

The technical objects to be achieved by this disclosure are not limited to the technical objects mentioned above, and other technical objects not mentioned can be clearly understood by those skilled in the art from the description below.

### Technical Solution

The present disclosure relates to a method and device for encoding/decoding images based on a region of interest for machine vision may include extract region of interest information in an image, perform an object tracking between frames based on the region of interest information, vary a resolution for each region of interest, and encode the image with the region of interest information.

In the present disclosure relates to a method and device for encoding/decoding images based on a region of interest for machine vision, an extraction of the region of interest information may be performed by using an object detection neural network from a current frame

In the present disclosure relates to a method and device for encoding/decoding images based on a region of interest for machine vision, the region of interest information may be information accumulated for an adjacent frame of the current frame according to a mode.

In the present disclosure relates to a method and device for encoding/decoding images based on a region of interest for machine vision, when the mode is an All Intra mode, the region of interest information may be not accumulated for the adjacent frame.

In the present disclosure relates to a method and device for encoding/decoding images based on a region of interest for machine vision, when the mode is a Random Access mode, the region of interest information may be accumulated by an intra period.

In the present disclosure relates to a method and device for encoding/decoding images based on a region of interest for machine vision, when the mode is a Low Dealy mode, the region of interest information may be accumulated by a specific number determined based on a frame rate.

In the present disclosure relates to a method and device for encoding/decoding images based on a region of interest for machine vision, varying the resolution for the each region of interest may be performed based on whether an object is detected by upscaling or downscaling the region of interest.

In the present disclosure relates to a method and device for encoding/decoding images based on a region of interest for machine vision, encoding the image with the region of interest information may perform an encoding of an image in which a region of interest is adjusted and a scale factor for each region of interest obtained from varying the resolution for the each region of interest.

In the present disclosure relates to a method and device for encoding/decoding images based on a region of interest for machine vision, the region of interest information may include a flag showing whether to perform a scaling of a region of interest.

In the present disclosure relates to a method and device for encoding/decoding images based on a region of interest for machine vision, the region of interest information may include information showing an accumulation cycle of a region of interest.

### Technical Effect

According to the present disclosure, the amount of data to be encoded/decoded can be reduced through preprocessing of an input image.

According to the present disclosure, by encoding/decoding an image transformed based on a region of interest, the effect of increasing compression efficiency while maintaining machine task performance may be exerted.

### BRIEF DESCRIPTION OF DRAWINGS

FIG. 1 is a block diagram of a video encoder according to an embodiment of the present disclosure.

FIG. 2 is a block diagram of a video decoder according to an embodiment of the present disclosure.

FIG. 3 shows units of an encoder device for a Region of Interest (ROI).

FIG. 4 shows a method for accumulating RoI information in an All intra mode.

FIG. 5 shows a method for accumulating RoI information in a Random Access mode.

FIG. 6 shows a method for accumulating RoI information in a Low Delay mode.

FIG. 7 shows units of a decoder device for a Region of Interest (ROI).

FIG. 8 shows an example of Region of Interest(ROI)-related syntax and semantics.

FIG. 9 shows an example of a ROI-based image encoding/decoding method for machine vision.

FIG. 10 shows an example of a ROI-based image encoder and decoder for machine vision.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

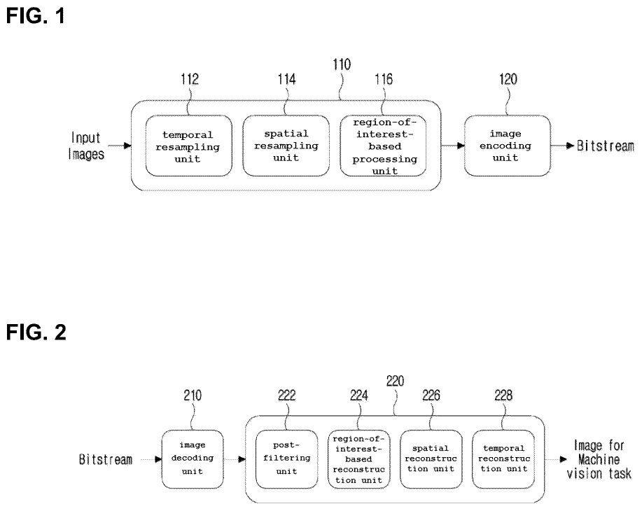

FIG. 1 is a block diagram of a video encoder according to an embodiment of the present disclosure.

Referring to FIG. 1, the video encoder may include a preprocessor 110 and an image encoding unit 120.

The preprocessor 110 performs a preprocessing process to convert input original images into images suitable for image encoding. Here, images input to the preprocessor 110 may be color or black-and-white images conforming to the YUV or YCbCr format.

The preprocessor 110 may include at least one of a temporal resampling unit 112, a spatial resampling unit 114, or a region-of-interest-based processing unit 116.

The temporal resampling unit 112 temporally resamples images. Only resampled images may be selected for image encoding. That is, encoding of some of the images input to the preprocessor 110 may be omitted through temporal resampling. For example, a 60 fps (frame per second) video may be converted into a 30 fps video by omitting odd-numbered images of the 60 fps video. Alternatively, images in a specific output order may be omitted by considering temporal redundancy between images.

The spatial resampling unit 114 spatially resamples an image. The size and/or spatial resolution of an image may be reduced through spatial resampling. For example, an image with a resolution of 1920×1080 may be converted to an image with a resolution of 960×540 or 480×270.

The region-of-interest-based processing unit 116 sets a region of interest in an image such that image encoding/decoding is performed focusing on information important to machine inference tasks. The region-of-interest-based processing unit 116 may remove a background region excluding the set region of interest or adjust the size and/or location of the region of interest in the image, so that the region of interest is set to be encoded/decoded with high quality.

The image encoding unit 120 encodes the image output from the preprocessing unit 110. Meanwhile, the image encoding unit 120 may encode the image using typical codec technology. As an example, the image encoding unit 120 may encode the image based on HEVC, VVC, or AV1. As a result of image encoding, a bitstream is generated and the generated bitstream may be transmitted to a video decoder.

FIG. 2 is a block diagram of a video decoder according to an embodiment of the present disclosure.

Referring to FIG. 2, the video decoder may include an image decoding unit 210 and a post-processor 220.

The image decoding unit 210 decodes a bitstream received from the video encoding unit 110 to generate a decoded or reconstructed image. The image decoding unit 210 may decode the bitstream based on the codec technology used in the image encoding unit 120.

The post-processor 220 performs post-processing on the decoded image. Through post-processing, the size and frame rate of the images may be restored to match the original images.

The post-processor 220 may include at least one of a post-filtering unit 222, a region-of-interest-based reconstruction unit 224, a spatial reconstruction unit 226, or a temporal reconstruction unit 218.

The post-filtering unit 222 applies filtering to reduce a reconstruction error of a decoded image. For example, the post-filtering unit 222 may apply an in-loop filter to the decoded image. The in-loop filter may include at least one of a deblocking filter, a sample adaptive offset filter, a luma mapping chroma scaling (LMCS) filter, or an adaptive loop filter.

The region-of-interest-based reconstruction unit 224 obtains an image of the same size as an original image based on region-of-interest information. For example, when a cropped image is encoded such that a region of interest is included therein, the decoded image has a different size from the original image. Accordingly, the region-of-interest-based reconstruction unit may adjust the retargeted image to the original size. Here, the retargeted image may represent a decoded image or an image on which upscaling has been performed through the spatial reconstruction unit 226. Alternatively, when the size or position of a region of interest in an encoding target image has been adjusted, the region of interest-based reconstruction unit 224 may adjust the position and size of the region of interest in the retargeted image to match the original image.

The spatial reconstruction unit 226 performs upscaling on a decoded image. The decoded image may be reconstructed to be an image having the same size and/or spatial resolution as the original image through upscaling.

The temporal reconstruction unit 228 reconstructs an image at a temporal position where encoding/decoding has been omitted through temporal resampling. Specifically, the temporal reconstruction unit 228 may generate an image at a temporal position where encoding/decoding has been omitted through interpolation between decoded images.

Meanwhile, in order to perform reverse processing on the image processing performed in the preprocessor 110, additional information may be encoded and signaled. The post-processor 220 may perform post-processing on decoded images based on the additional information to generate images for machine inference. The additional information may be referred to as “metadata”.

Metadata may include at least one of temporal resampling information, spatial resampling information, or region-of-interest processing information.

The temporal resampling information may include at least one of a flag indicating whether temporal resampling has been performed or information indicating a temporal resampling rate.

For example, the flag indicates that temporal resampling has been performed when set to 1. In this case, information indicating a temporal resampling rate may be additionally encoded/decoded. When temporal resampling is performed, fewer images than the number of original images may be encoded/decoded. The video decoder can reconstruct images for which encoding/decoding has been omitted through temporal reconstruction.

On the other hand, the flag indicates that temporal resampling has not been performed when set to 0.

The temporal resampling rate may be represented as an exponent of 2. For example, a temporal resampling rate of 2\hat{ }N indicates that one of 2\hat{ }N images is selected as an encoding/decoding target image. For example, only images having a picture order count (POC) of a multiple of 2\hat{ }N can be encoded/decoded. Information representing the temporal resampling rate may represent the exponent (i.e., N) of the temporal resampling rate. As an example, the information may represent the exponent value of the temporal resampling rate or the value obtained by subtracting 1 from the exponent value.

The spatial resampling information may include at least one of a flag indicating whether spatial resampling has been performed or information indicating a scaling parameter for spatial resampling.

As an example, the flag indicates that spatial resampling has been performed when set to 1. In this case, information representing a scaling parameter may be additionally encoded. Specifically, information representing a horizontal scaling parameter and information representing a vertical scaling parameter may be encoded, respectively, and the encoded information may be signaled. When spatial resampling is performed, the size and/or spatial resolution of an image may be reduced. The video decoder may restore the size of a decoded image to the size of the original image or a pre-defined size, through spatial reconstruction. Meanwhile, information, indicating the pre-defined size, may be further encoded/decoded.

The flag indicates that spatial resampling has not been performed when set to 0.

The region-of-interest processing information may include at least one of image size information or region-of-interest information.

The image size information may include information indicating whether retargeting has been performed. If the retargeting flag is 1, it indicates that the retargeted image is encoded/decoded instead of the original image. On the other hand, if the retargeting flag is 0, it indicates that the original image is encoded/decoded as is.

The retargeted image indicates an image generated by performing at least one of resolution adjustment and position adjustment on at least one region of interest in the original image. Accordingly, the resolution or position of the region of interest in the retargeted image may be different from that of the original image. In addition, the size of the retargeted image may be the same as or smaller than that of the original image.

When retargeting is allowed (i.e., if the retargeting flag is 1), the size information of the retargeted image may be encoded/decoded. The size information of the retargeted image may include width information of the image and height information of the image.

Meanwhile, information indicating the size difference between the original image and the retargeted image may be additionally encoded/decoded. For example, information indicating whether a size difference between the size of the retargeted image and the size of the original image is encoded/decoded or not may be encoded/decoded.

For example, when the information, indicating whether the size difference is encoded/decoded or not, is 0, it indicates that the size difference between the retargeted image and the original image is not encoded/decoded.

On the other hand, when the information, indicating whether the size difference is encoded/decoded or not, is 1, it indicates that the size difference between the retargeted image and the original image is encoded/decoded. In this case, information indicating the size difference between the size of the retargeted image and the size of the original image may be additionally encoded/decoded.

The information representing the size difference indicates the size difference between the original image and the retargeted image. Information representing the size difference in the horizontal direction and information representing a size difference in the horizontal direction may be encoded and signaled, respectively.

The region-of-interest information may include at least one of a flag indicating whether a region of interest is present, information on the number of regions of interest, a scaling parameter of a region of interest, or position information of a region of interest.

For example, when the flag is 1, it indicates that information on a region of interest may be encoded/decoded. In this case, at least one of the number of regions of interest, scaling parameter information of a region of interest, position information of a region of interest, or size information of a region of interest may be additionally encoded/decoded.

On the other hand, when the flag is 0, it indicates that a region of interest is not present.

The information on the number of regions of interest indicates the number of regions of interest. Meanwhile, the number of regions of interest may be calculated in units of image groups including at least one image.

A scaling parameter of a region of interest represents the scaling parameter with respect to the region of interest. Depending on the scaling parameter of the region of interest, the size of the region of interest may be adjusted.

Scaling parameter information of a region of interest may include information indicating whether the scaling parameter of the region of interest is updated. If the information, indicating whether the region of interest is updated or not, indicates that the scaling parameter of the region of interest will not be updated, the scaling parameter of the region of interest may be set to a default value or the same value as in the previous frame. On the other hand, when the information, indicating whether the region of interest is updated or not, indicates that the scaling parameter of the region of interest needs to be updated, the information indicating the scaling parameter of the region of interest may be additionally encoded/decoded.

Meanwhile, scaling parameter information of a region of interest may be encoded/decoded individually for each region of interest.

Position information of a region of interest indicates the position of the region of interest in the original image. The horizontal position (i.e., x-axis coordinate) information and vertical position (i.e., y-axis coordinate) information of the region of interest may be encoded/decoded.

Size information of a region of interest indicates the size of the region of interest in the original image. The horizontal size (i.e., width) information and the vertical size (i.e., height) information of the region of interest may be encoded/decoded.

As described above, according to the present disclosure, through the preprocessing process of the image, the encoding/decoding efficiency of the image may be improved while maintaining the machine task performance.

In an embodiment below, a method and a device for a ROI-based image encoding/decoding for machine vision are described in detail.

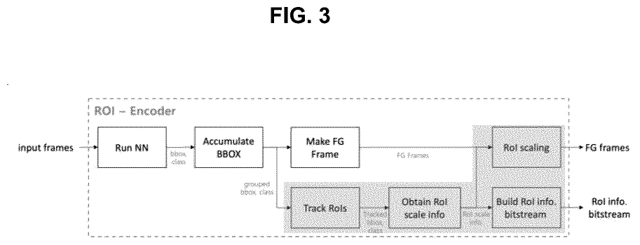

FIG. 3 shows units of an encoder device for a Region of Interest (ROI).

Each device in FIG. 3 may be expressed as a unit. For example, Run NN in FIG. 2 may be a Run NN unit. However, for convenience of a description, it is described below by omitting the expression of a unit.

Run NN may use an object detection neural network to extract RoI information (class id, bbox) from an input frame.

Accumulate BBOX may accumulate RoI information to allocate the same RoI scale factor to an adjacent frame to the advantage of inter coding in Random Access (RA) and Low Delay (LD) modes.

Specifically, when a mode is an All Intra (AI) mode, RoI information is extracted separately for each frame, and an adjacent frame and RoI information may not be accumulated.

In addition, when a mode is a Random Access mode, RoI information may be accumulated by an intra period.

In addition, when a mode is a Low Delay mode, RoI information may be accumulated by a specific number of previous frames (e.g., frame_rate).

Make FG Frame may create a Foreground (FG) Frame based on accumulated RoI information.

Track RoIs may perform RoI tracking to allocate the same RoI scale factor to an adjacent frame. Specifically, Track RoIs may search RoI information based on roi_accumulation_period and perform RoI tracking. In this case, a tracking neural network is not used, and a tracking ID may be allocated by using a relationship among a previous frame, IoU and class ID information.

In order to extract scale information for ROI detected for each frame, Obtain RoI scale info may down-sample and compress a frame to a set scale factor to check if an object is detected from a corresponding scale factor. In addition, compression is performed from the smallest scale factor and scaling may be performed with a larger scale factor.

As an example, when a scale factor is 50%→75% (when only down-sampling is performed), compression may be first performed with a scale factor of 50% to check if an object is detected from a corresponding scale factor and if it is not detected, compression may be performed with a scale factor of 75% to check if an object is detected from a corresponding scale factor. It may be a case in which bitrate reduction is prioritized.

As an example, when a scale factor is 60%→70%→80%→90% (only down-sampling is performed), compression may be first performed with a scale factor of 60% to check if an object is detected from a corresponding scale factor, and if it is not detected, compression may be performed with a scale factor of 70% to check if an object is detected from a corresponding scale factor and it may be performed in order of 80% and 90% in the same way. It may be a case in which bitrate reduction is prioritized.

As an example, when a scale factor is 50%→75%→100% or 120% (when it is greater than or equal to an original scale), compression may be first performed with a scale factor of 50% to check if an object is detected from a corresponding scale factor, and if it is not detected, compression may be performed with a scale factor of 75% to check if an object is detected from a corresponding scale factor, and if it is not detected, compression may be performed with an original scale (100%) or a scale greater than an original scale (120%) to check if an object is detected. It may be a case in which machine performance is prioritized.

In RoI scaling, downsampling or upsampling may be performed, and a ROI may be downsampled or upsampled based on scale information obtained in a previous step.

Scaling is performed on a RoI that does not overlap with another RoI, and for a RoI that overlaps with another RoI, downsampling may be performed with a scale factor by considering a case in which reconstruction is not properly performed in decoding, and then upsampling may be performed with an original scale (100%) (up-sampling after down-sampling results in a bit reduction due to a smoothing effect).

As an example, since a RoI scaling LD mode performs encoding by referring to a previous frame, scaling may be performed again to an original scale after sampling for all RoIs (for coding gain in inter prediction).

Build RoI info. A bitstream may transmit RoI information (a scale factor, a bbox coordinate, etc.) required for up-sampling in a decoding process. As an embodiment, a scale factor may be delivered together with another scale information. Here, another scale information may include next_roi_scale_group_flag information.

A method for accumulating RoI information in an encoder for each mode may be different. The specific details are described below.

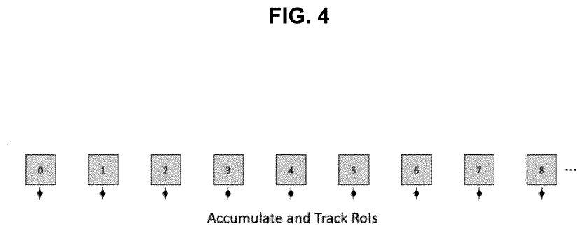

FIG. 4 shows a method for accumulating RoI information in an All intra mode.

In an All Intra mode, RoI information is extracted separately for each frame and an adjacent frame and RoI information may not be accumulated.

Specifically, it may have a value of roi_accumulation_period=1, and RoI information may not be accumulated because RoI information is extracted separately for each frame. For reference, information on the syntax and semantics of roi_accumulation_period is described later.

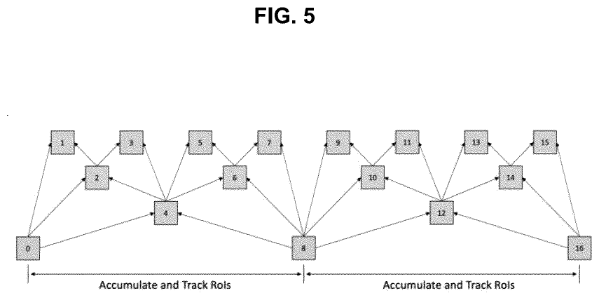

FIG. 5 shows a method for accumulating RoI information in a Random Access mode.

In Random Access, RoI information may be accumulated by an intra period.

Specifically, it may be roi_accumulation_period=item.args.IntraPeriod, and RoI information may be accumulated in an intra-period unit.

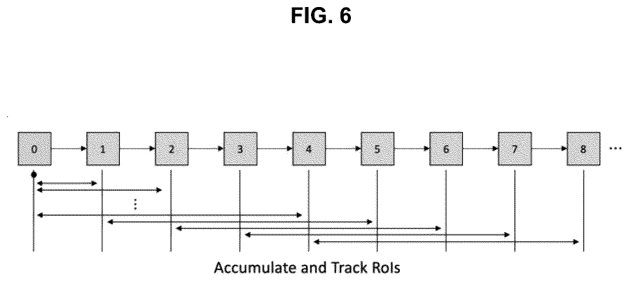

FIG. 6 shows a method for accumulating RoI information in a Low Delay mode.

In Low Delay, RoI information may be accumulated by a specific number of previous frames. The specific number may be determined based on a frame rate. Alternatively, the specific number may be information signaled in a bitstream.

Specifically, it may be roi_accumulation_period=current_frame_id-frame_rate (when roi_accumulation_period is negative, it is set as 0), and frame_rate may be used for an input video to accumulate RoI information by the number of frame_rates among the previous frames.

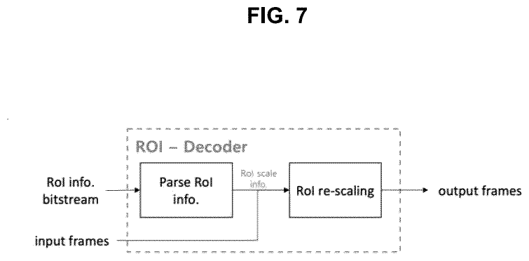

FIG. 7 shows units of a decoder device for a Region of Interest (ROI).

Each device in FIG. 7 may be expressed as a unit. For example, Run NN in FIG. 2 may be a Run NN unit. However, for convenience of a description, it is described below by omitting the expression of a unit.

In order to reconstruct a scaled RoI on an encoding side, re-scaling may be performed with an original scale factor on a decoding side.

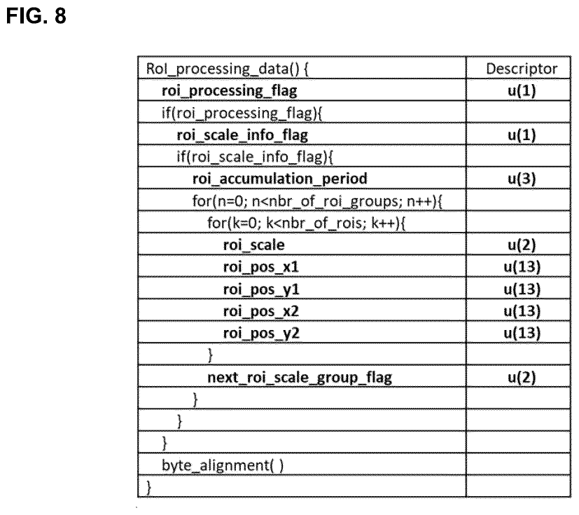

Parse RoI info may parse a RoI scale factor and a RoI coordinate from a bitstream including RoI information transmitted in an encoding step. The specific example of a RoI obtained from the bitstream is covered in FIG. 8 below.

RoI re-scaling may perform re-scaling with an original RoI scale for an input frame based on information parsed from a scaled RoI. As an example, re-scaling may represent upsampling.

FIG. 8 shows an example of Region of Interest(ROI)-related syntax and semantics.

roi_processing_flag represents whether RoI component is performed, and when RoI component is performed, 1 may be transmitted, and otherwise, 0 may be transmitted.

Roi_scale_info_flag represents whether RoI scaling processing is performed, and when RoI scaling processing is performed, 1 may be transmitted, and otherwise, 0 may be transmitted.

roi_accumulation_period may represent RoI accumulation period information. RoI accumulation period may vary depending on each mode (AI, RA, LD). As an embodiment, when the corresponding information is not signaled from a bitstream, it may represent a basic value of 64.

Roi_scale may represent scale factor information.

As an example, referring to a syntax in FIG. 7, scale factor 50% may transmit 01 and scale factor 75% may transmit 10. In order to avoid confusion between the scale factor and next_roi_scale_group_flag information in decoding, 2 bits may be allocated every time.

As an example, when roi_scale is 00, it may represent next_roi_group_flag, no next roi group, when it is 01, it may represent scale factor 50%, when it is 10, it may represent scale factor 75% and when it is 11, it may represent next_roi_group_flag, next roi group exists.

roi_pos_x1 may represent x1 coordinate information.

roi_pos_y1 may represent y1 coordinate information.

roi_pos_x2 may represent x2 coordinate information.

roi_pos_y2 may represent y2 coordinate information.

As an example, a ROI may be specified by two coordinates [(x1, y1) and (x2, y2)].

For example, a coordinate (x1, y1) may represent the top-left coordinate of a RoI and (x2, y2) may represent the bottom-right coordinate of a RoI. For example, a coordinate (x1, y1) may represent the top-right coordinate of a RoI and (x2, y2) may represent the bottom-left coordinate of a RoI. For example, a coordinate (x1, y1) may represent the center coordinate of a RoI and (x2, y2) may represent the bottom-right coordinate of a RoI. In other words, each coordinate may be a coordinate representing any one of top-left, top, top-right, left, bottom-left, bottom, bottom-right, right or center positions of a RoI.

next_roi_scale_group_flag represents whether there is a next roi scale group, and when there is a next roi scale group, 11 may be transmitted and when there is no next roi scale group, 00 may be transmitted.

nbr_of_roi_groups represents the number of frame groups accumulating a RoI within a corresponding sequence and may be information obtained implicitly, not signaled information.

nbr_of_rois represents the number of RoIs belonging to a corresponding group and may be information obtained implicitly, not signaled information.

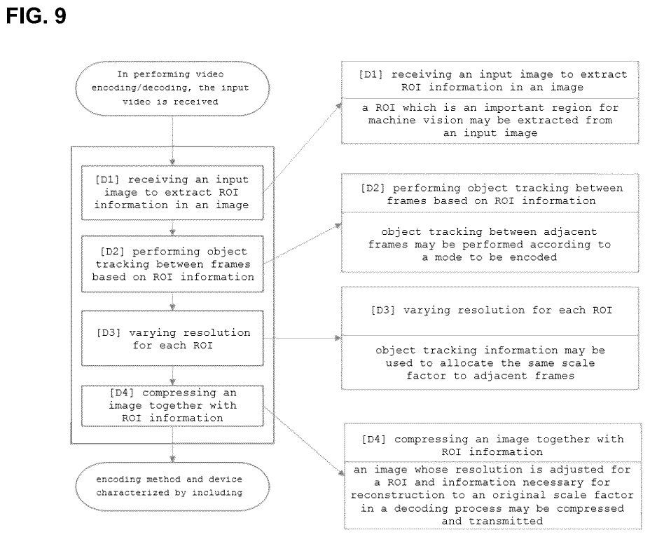

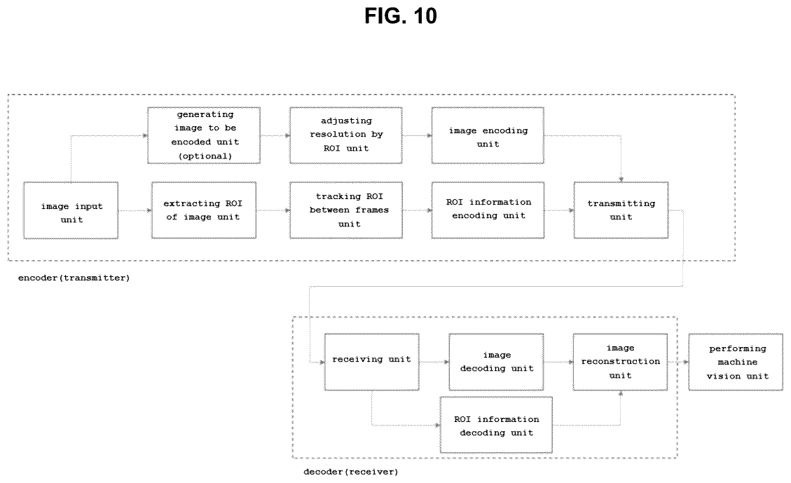

FIG. 9 shows an example of a ROI-based image encoding/decoding method for machine vision.

A method for performing ROI-based image encoding/decoding for machine vision may include at least one of [D1] receiving an input image to extract ROI information in an image, [D2] performing object tracking between frames based on ROI information, [D3] varying resolution for each ROI or [D4] compressing an image together with ROI information.

In [D1] extracting ROI information in an image, a ROI which is an important region for machine vision may be extracted from an input image.

In [D2] performing object tracking between frames based on ROI information, object tracking between adjacent frames may be performed according to a mode to be encoded.

In [D3] varying resolution for each ROI, object tracking information may be used to allocate the same scale factor to adjacent frames.

In [D4] compressing an image together with ROI information, an image whose resolution is adjusted for a ROI and information necessary for reconstruction to an original scale factor in a decoding process may be compressed and transmitted.

FIG. 10 shows an example of a ROI-based image encoder and decoder for machine vision.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. An image encoding method, the method comprising:
extracting region of interest information in an image;
performing an object tracking between frames based on the region of interest information;
varying a resolution for each region of interest; and
encoding the image with the region of interest information.

2. The method of claim 1, wherein an extraction of the region of interest information is performed by using an object detection neural network from a current frame.

3. The method of claim 2, wherein the region of interest information is information accumulated for an adjacent frame of the current frame according to a mode.

4. The method of claim 3, wherein when the mode is an All Intra mode, the region of interest information is not accumulated for the adjacent frame.

5. The method of claim 3, wherein when the mode is a Random Access mode, the region of interest information is accumulated by an intra period.

6. The method of claim 3, wherein when the mode is a Low Dealy mode, the region of interest information is accumulated by a specific number determined based on a frame rate.

7. The method of claim 1, wherein varying the resolution for the each region of interest is performed based on whether an object is detected by upscaling or downscaling the region of interest.

8. The method of claim 1, wherein:
encoding the image with the region of interest information performs an encoding of an image in which a region of interest is adjusted and a scale factor for each region of interest obtained from varying the resolution for the each region of interest.

9. The method of claim 1, wherein the region of interest information includes a flag showing whether to perform a scaling of a region of interest.

10. The method of claim 1, wherein the region of interest information includes information showing an accumulation cycle of a region of interest.

11. An image decoding method, the method comprising:
decoding an image with region of interest information; and
based on the region of interest information, reconstructing regions of interest of the image to an original scale,
wherein the image is an image in which a resolution is adjusted differently for each region of interest.

12. The method of claim 11, wherein the region of interest information includes coordinate information specifying a region of interest of the image.

13. The method of claim 11, wherein the region of interest information includes information accumulated for an adjacent frame of a current frame according to a mode.

14. The method of claim 13, wherein when the mode is an All Intra mode, the region of interest information is information not accumulated for the adjacent frame.

15. The method of claim 13, wherein when the mode is a Random Access mode, the region of interest information is information accumulated by an intra period.

16. The method of claim 13, wherein when the mode is a Low Dealy mode, the region of interest information is information accumulated by a specific number determined based on a frame rate.

17. The method of claim 11, wherein reconstructing the regions of interest of the image to the original scale is performed by upscaling or downscaling a region of interest based on the region of interest information.

18. The method of claim 11, wherein the region of interest information includes a flag showing whether to perform a scaling of a region of interest.

19. The method of claim 11, wherein the region of interest information includes information showing an accumulation cycle of a region of interest.

20. A method for transmitting a bitstream, the method comprising:
extracting region of interest information in an image;
performing an object tracking between frames based on the region of interest information;
varying a resolution for each region of interest;
encoding the image with the region of interest information to generate the bitstream; and
transmitting the bitstream.
